(19) United States
(12) Patent Application Publication
(10) Pub. No.: US 2006/0023744 A1
(43) Pub. Date: Feb. 2, 2006

(54) Network address-port translation apparatus and method for IP fragment packets

(76) Inventors: Jin Ru Chen, Taichung City (TW); Chun Feng Liu, Taipei City (TW); Tzong Yn Su, Tainan City (TW)

Correspondence Address: Raymond Sun, 12420 Woodhall Way, Tustin, CA, 92782, US

(21) Appl. No.: 11/191,363

(22) Filed: Jul. 27, 2005

(30) Foreign Application Priority Data
Jul. 28, 2004 (TW) 093122623

(51) Int. Cl. H04J 3/22; H04J 3/16

(52) U.S. Cl. 370/466

(57) ABSTRACT

A network address-port translation (NAPT) apparatus and method for IP packets with a same identification is disclosed. The IP packets at least include a first packet with Layer 4 information and a second packet without Layer 4 information. The NAPT apparatus includes: a packet translation unit for performing a NAPT operation for the first packet to generate a translation IP; and a translation table for storing a correspondence between the same identification and the translation IP. The packet translation unit translates one of a source IP and a destination IP of the second packet into the translation IP according to a forwarding direction of the second packet and the translation table.

### BACKGROUND OF THE INVENTION

(a). Field of the Invention

The present invention relates to the network system, and more particularly to the field of network address-port translation (NAPT).

(b). Description of the Prior Arts

The Internet transceives data by TCP/IP protocols that adopt IP addressing system, which renders a unique IP address to each network node on the Internet to facilitate data transmission. To solve the IP inadequacy problem, Network Address Translation (NAT) and Network Address-Port Translation (NAPT) are developed.

If a node with a private IP needs to access external networks (e.g. the Internet), a NAT/NAPT-enabled equipment such as a router is needed, as shown in FIG. 1. The conventional NAT/NAPT-enabled equipment uses a built-in CPU to run associated software for NAT/NAPT, i.e., the NAT/NAPT function is implemented by software and indirectly performed. A public IP is a normal IP used in various networks which apply TCP/IP protocols, while a private IP is only used in an internal network, such as the local area network (LAN) of an institution or family. That is, the private IP cannot be used to connect directly to external networks.

In NAT, because of one-to-one correspondence between public and private IPs, N public IPs can only serve for N private IPs. In NAPT, correspondence between private and public IPs is not one-to-one, so more computers can connect to the Internet simultaneously by using different combinations of public IPs and associated ports.

However, in some situations such as data volume is too large, the network using TCP/IP protocols will divide a sum of data into multiple sections for transmission by a series of IP packets, which are called IP fragment packets. Each IP fragment packet transmits one of the data sections. All IP fragment packets within a same series have a same identification in their IP headers. In the same series, the fragment offset and the more fragments (MF) flag of the first packet are 0 and 1 respectively, and for any subsequent IP fragment packet, the fragment offset is not 0 and the MF flag is 1 (except the MF flag of the last packet is 0). The fragment offset and MF flag are both within the IP header. The fragment offset records where the data carried in the underlying packet is located in the whole sum of data, and the MF flag indicates whether there is any subsequent IP fragment packet. For more detailed information about this, please see RFC.791.

The conventional NAPT devices need Transmission Layer (Layer 4) information of a packet when performing a NAPT operation for the packet. Since only the first packet has a Layer 4 header within a series of IP fragment packets, the conventional NAPT device will forward subsequent packets in the series to a central processing unit (CPU) for processing with software.

### SUMMARY OF THE INVENTION

It is therefore an object of the present invention to provide a NAPT apparatus and method that can directly perform a NAPT operation for IP fragment packets by hardware circuits.

Another object of the present invention is to provide a switch controller including a NAPT apparatus, which can directly perform a NAPT operation for IP fragment packets by hardware circuits.

According to an embodiment of the present invention, a NAPT apparatus for IP packets with a same identification is provided. The IP packets at least include a first packet with Layer 4 information and a second packet without Layer 4 information. The NAPT apparatus includes a packet translation unit for performing a NAPT operation for the first packet to generate a translation IP, and a translation table for storing a correspondence between the same identification and the translation IP. The packet translation unit also translates one of a source IP and a destination IP of the second packet into the translation IP according to a forwarding direction of the second packet and the translation table.

Preferably, the IP packets are IP fragment packets.

According to another embodiment of the present invention, a NAPT method for IP packets with a same identification is provided. The IP packets at least include a first packet with Layer 4 information and a second packet without Layer 4 information. The NAPT method includes following steps: performing a NAPT operation for the first packet to generate a translation IP; storing a correspondence between the same identification and the translation IP into a translation table; and translating one of a source IP and a destination IP of the second packet into the translation IP according to a forwarding direction of the second packet and the translation table.

### BRIEF DESCRIPTION OF THE DRAWINGS

FIG. 1 is a diagram showing that nodes with private IPs in an internal network connect to an external network via a NAT/NAPT-enabled router.

FIG. 2 is a block diagram of a preferred embodiment of the NAPT apparatus according to the present invention.

FIG. 3 is a block diagram showing a format of the translation table in FIG. 2.

FIG. 4 is a flow chart of processing an IP fragment packet with a Layer 4 header according to a preferred embodiment of the NAPT method of the present invention.

FIG. 5 is a flow chart of processing an IP fragment packet without a Layer 4 header according to a preferred embodiment of the NAPT method of the present invention.

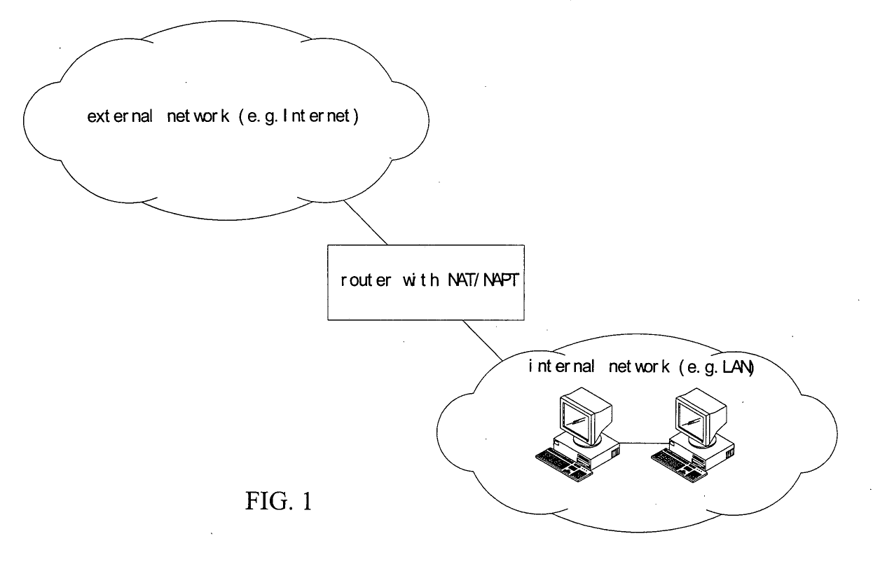

### DETAILED DESCRIPTION OF THE PRESENT INVENTION

In this specification, “internal-to-external” means a forwarding direction from an internal network to an external network, and an “external-to-internal” means a forwarding direction from an external network to an internal network.

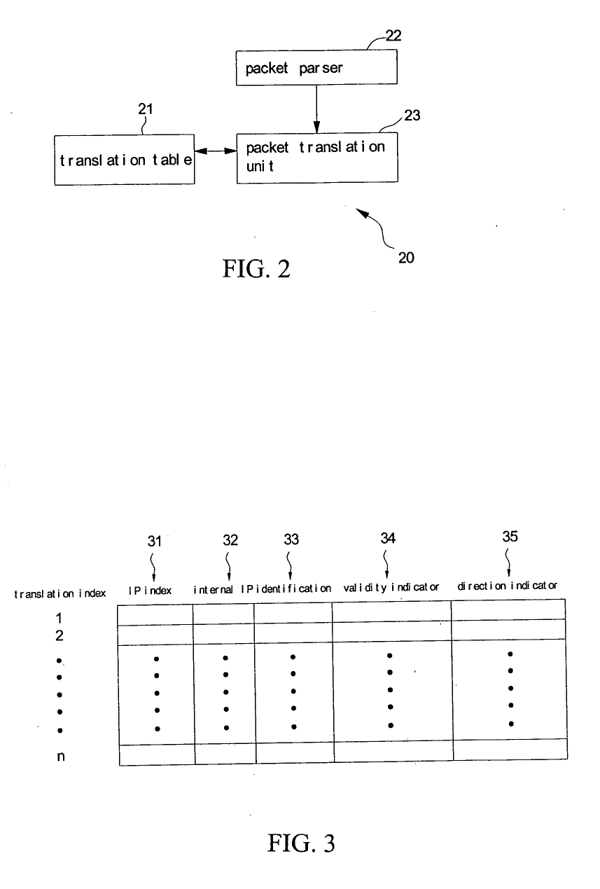

FIG. 2 is a block diagram of a preferred embodiment of the NAPT apparatus according to the present invention. The NAPT apparatus 20 lies between an external network and an internal network where internal IPs and internal ports are used, and directly performs a NAPT operation for IP fragment packets traveling between the internal and external networks by hardware circuits. As shown in FIG. 2, the NAPT apparatus 20 includes: a translation table 21, a packet parser 22, and a packet translation unit 23. The packet parser 22 is for parsing content of a received IP fragment packet. The packet translation unit 23, coupled to the packet parser 22, performs a corresponding translation operation according to whether the received IP fragment packet has a Layer 4 header. When the IP fragment packet has a Layer 4 header, i.e. the packet is the first one within a series of IP fragment packets, the packet translation unit 23 performs a NAPT operation for it, and stores into the translation table 21 the information required for translating a subsequent IP fragment packet without the Layer 4 header in the same series. When the received IP fragment packet hasn't a Layer 4 header, the packet translation unit 23 translates the packet according to its forwarding direction and the translation table 21, as described later.

It is notable that the manner in which the packet translation unit 23 performs the NAPT operation for the IP fragment packet with a Layer 4 header is unlimited. In one embodiment, the packet translation unit 23 includes a NAPT apparatus disclosed in U.S. patent application Ser. No. 10/430,346, filed on 2003/5/7, now U.S. Pub. No. 2003/0210691, thereby performing the NAPT operation for the IP fragment packet with a Layer 4 header. The above-mentioned application is hereby incorporated by reference.

FIG. 3 is a block diagram showing a format of the translation table 21 in FIG. 2. The translation table 21 is a cache memory with n entries, where n is a positive integer. Each entry corresponds to a translation index, and stores information generated according to the first one of a series of IP fragment packets and required for translating a subsequent one in the series. Each entry includes below fields:

IP index 31: this field is used to determine an external IP. In one embodiment, the IP index 31 is for indexing an external IP table to select a corresponding external IP therein. The external IP table stores external IPs necessary for performing a translation operation for IP fragment packets. The length of this field is determined based on the size of the external IP table. In another embodiment, this field stores an external IP directly.

Internal IP 32: if the IP fragment packet with a Layer 4 header is an internal-to-external packet, this field records a source IP of this packet; if an external-to-internal packet, this field records a translated destination IP of this packet after the NAPT operation. This field is 32 bits long according to the current IP version.

Identification 33: this field records a packet identification for the same series of IP fragment packets. The packet identification, 16 bits long, is stored in the IP header of an IP fragment packet.

Validity indicator 34: this field is used to indicate whether the content of the underlying entry is valid. In one embodiment, the validity indicator 34 is a validity bit, and the bit values of 1 and 0 represent valid and invalid respectively.

Direction indicator 35: this field is used to indicate a forwarding direction of the series of IP fragment packets. In one embodiment, the direction indicator 35 is a direction bit, and the bit values of 1 and 0 represent internal-to-external and external-to-internal respectively.

It is well known to one skilled in the art that the type of cache memory used to implement the translation table 21, such as a direct-mapped cache, a fully associative cache, or a multiway set-associative cache, is unlimited and also irrelevant to the objects of the present invention.

When the NAPT apparatus 20 receives an IP fragment packet with a Layer 4 header (denoted by first packet), the packet parser 22 parses its content, and the packet translation unit 23 inputs the identification, source IP, and destination IP of the first packet to a hash function to generate a translation index, which is for selecting a corresponding entry (denoted by first entry) in the translation table 21. The packet translation unit 23 also performs the NAPT operation for the first packet. The first packet can be identified by examining the fragment offset and MF flag in its IP header (i.e. the fragment offset and MF flag are 0 and 1 respectively). It is notable that the translation index generated by the hash function is randomly distributed among different packets such that the entries of the translation table 21 can be utilized averagely. However, the type of the hash function is unlimited, and thus MD5, CRC, XOR, or any other hash algorithm can be used in the present invention.

Next, the packet translation unit 23 checks the validity indicator 34 of the first entry. If the first entry is valid, it means that the first entry is currently used by another series of IP fragment packets. Since a collision occurs, the packet translation unit 23 forwards the first packet to a CPU (not shown) for subsequent processing. If the first entry is invalid, the packet translation unit 23 configures the first entry according to the forwarding direction of the first packet:

(1) If the first packet is internal-to-external, the packet translation unit 23 stores the original source IP and identification of the first packet into the internal IP 32 and identification 33 fields of the first entry respectively. Meanwhile, an IP index corresponding to a translated source IP of the first packet after the NAPT operation is stored into the IP index field 31. The validity indicator 34 and direction indicator 35 fields are configured as valid and internal-to-external respectively.

(2) If the first packet is external-to-internal, the packet translation unit 23 stores a translated destination IP and identification of the first packet after the NAPT operation into the internal IP 32 and identification 33 fields of the first entry respectively. Meanwhile, an IP index corresponding to the original destination IP of the first packet is stored into the IP index field 31. The validity indicator 34 and direction indicator 35 fields are configured as valid and external-to-internal respectively.

After the first entry is configured, the packet translation unit 23 translates any subsequent IP fragment packet (denoted by second packet) within the same series as the first packet according to the first entry:

(1) First, the packet translation unit 23 inputs the identification, source IP, and destination IP of the second packet to the above hash function to generate a corresponding translation index, which is for selecting a corresponding entry in the translation table 21. Since the first and second packets belong to the same series, the identification, source IP, and destination IP of the second packet are also the same as those of the first packet. Thus, the selected corresponding entry is the first entry.

(2) If the second packet is internal-to-external, the packet translation unit 23 determines whether the identification and source IP of the second packet equal to the identification 33 and internal IP 32 of the first entry respectively, and whether the direction indicator 35 shows internal-to-external. If the determining results are all positive, the source IP of the second packet is translated into the external IP (i.e. the translated source IP of the first packet) corresponding to the IP index 31 of the first entry If the determining results are not all positive, the second packet is forwarded to the CPU for subsequent processing.

(3) If the second packet is external-to-internal, the packet translation unit 23 determines whether the identification and destination IP of the second packet equal to the identification 33 of the first entry and the external IP (i.e. the original destination IP of the first packet) corresponding to the IP index 31 of the first entry respectively, and whether the direction indicator 35 shows external-to-internal. If the determining results are all positive, the destination IP of the second packet is translated into the internal IP 32 of the first entry. If the determining results are not all positive, the second packet is forwarded to the CPU for subsequent processing.

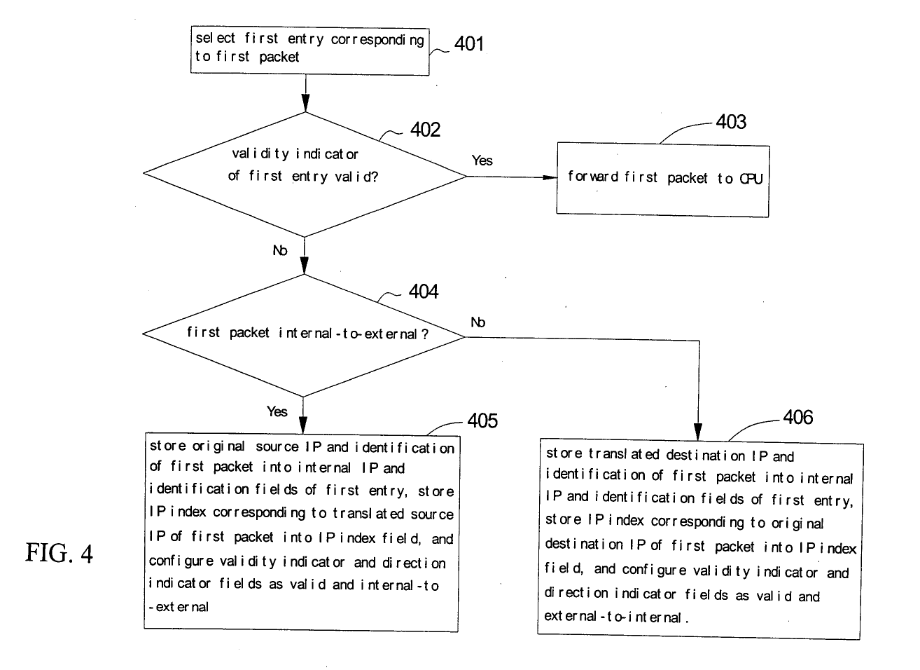

FIG. 4 is a flow chart of processing an IP fragment packet with a Layer 4 header (denoted by first packet) according to a preferred embodiment of the NAPT method of the present invention. As shown in FIG. 4, the flow includes steps of:
401 selecting a first entry in the translation table 21 corresponding to the first packet;
402 determining whether the validity indicator 34 of the first entry shows valid, if no then jumping to step 404; otherwise proceeding to step 403;
403 forwarding the first packet to a CPU and completing the flow;
404 determining whether the first packet is internal-to-external, if no then jumping to step 406; otherwise proceeding to step 405;
405 storing the original source IP and identification of the first packet into the internal IP 32 and identification 33 fields of the first entry respectively, storing an IP index corresponding to a translated source IP of the first packet into the IP index field 31, configuring the validity indicator 34 and direction indicator 35 fields as valid and internal-to-external respectively, and completing the flow; and
406 storing a translated destination IP and identification of the first packet into the internal IP 32 and identification 33 fields of the first entry respectively, storing an IP index corresponding to the original destination IP of the first packet into the IP index field 31, configuring the validity indicator 34 and direction indicator 35 fields as valid and external-to-internal respectively, and completing the flow.

In step 401, the identification, source IP, and destination IP of the first packet are inputted to a hash function to generate a translation index, which is used to select the corresponding first entry in the translation table 21.

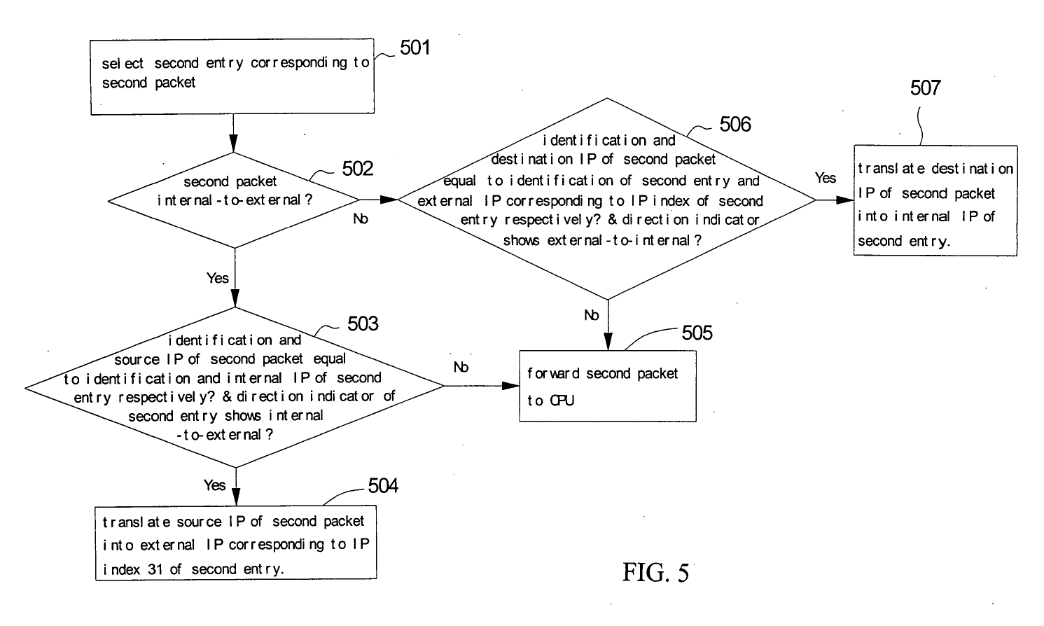

FIG. 5 is a flow chart of processing an IP fragment packet without a Layer 4 header (denoted by second packet) according to a preferred embodiment of the NAPT method of the present invention. As shown in FIG. 5, the flow includes steps of:
501 selecting a second entry in the translation table 21 corresponding to the second packet;
502 determining whether the second packet is internal-to-external, if no then jumping to step 506; otherwise proceeding to step 503;
503 determines whether the identification and source IP of the second packet equal to the identification 33 and internal IP 32 of the second entry respectively, and whether the direction indicator 35 of the second entry shows internal-to-external, if all yes then proceeding to step 504; otherwise jumping to step 505;
504 translating the source IP of the second packet into the external IP corresponding to the IP index 31 of the second entry, and completing the flow;
505 forwarding the second packet to the CPU for subsequent processing, and completing the flow;
506 determining whether the identification and destination IP of the second packet equal to the identification 33 of the second entry and the external IP corresponding to the IP index 31 of the second entry respectively, and whether the direction indicator 35 shows external-to-internal, if all yes then proceeding to step 507, otherwise jumping to step 505; and
507 translating the destination IP of the second packet into the internal IP 32 of the second entry.

In step 501, the second entry is selected in the same manner as step 401. If the determining results of step 503 are all positive, the second packet belongs to a same series as an internal-to-external IP fragment packet used for establishing the second entry, and then the source IP of the second packet is translated in step 504. If the determining results of step 506 are all positive, the second packet belongs to a same series as an external-to-internal IP fragment packet used for establishing the second entry, and then the destination IP of the second packet is translated in step 507. If the determining results of step 503 or 506 are not all positive, a collision occurs and the second packet is then forwarded to the CPU in step 505.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A network address-port translation (NAPT) apparatus for a plurality of IP packets with a same identification, the IP packets comprising a first packet with Layer 4 information and a second packet without Layer 4 information, the apparatus comprising:
a packet translation unit for performing a NAPT operation for the first packet to generate a translation IP; and
a translation table, coupled to the packet translation unit, for storing a correspondence between the same identification and the translation IP;
wherein the packet translation unit translates one of a source IP and a destination IP of the second packet into the translation IP according to a forwarding direction of the second packet and the translation table.

2. The apparatus of claim 1, wherein the IP packets are IP fragment packets.

3. The apparatus of claim 1, wherein if the first packet is forwarded from an internal network to an external network, the translation IP is an external source IP of the first packet after the NAPT operation.

4. The apparatus of claim 3, wherein if the second packet is forwarded from the internal network to the external network, the packet translation unit translates the source IP of the second packet into the translation IP.

5. The apparatus of claim 1, wherein if the first packet is forwarded from an external network to an internal network, the translation IP is an internal destination IP of the first packet after the NAPT operation.

6. The apparatus of claim 5, wherein if the second packet is forwarded from the external network to the internal network, the packet translation unit translates the destination IP of the second packet into the translation IP.

7. The apparatus of claim 1, wherein the packet translation unit selects one of a plurality of storage elements of the translation table according to the same identification, a source IP and a destination IP of one of the IP packets.

8. The apparatus of claim 7, wherein the packet translation unit selects the corresponding storage element by a hash function.

9. The apparatus of claim 7, wherein each of the storage elements stores a direction indicator for indicating a forwarding direction corresponding to the underlying storage element.

10. The apparatus of claim 7, wherein each of the storage elements stores a validity indicator for indicating whether content of the underlying storage element is valid.

11. The apparatus of claim 1, further comprising a packet parser for parsing content of the IP packets.

12. A switch controller comprising the NAPT apparatus of claim 1.

13. A network address-port translation (NAPT) method for a plurality of IP packets with a same identification, the IP packets at least comprising a first packet with Layer 4 information and a second packet without Layer 4 information, the method comprising:
performing a NAPT operation for the first packet to generate a translation IP;
storing a correspondence between the same identification and the translation IP into a translation table; and
translating one of a source IP and a destination IP of the second packet into the translation IP according to a forwarding direction of the second packet and the translation table.

14. The method of claim 13, wherein the IP packets are IP fragment packets.

15. The method of claim 13, wherein if the first packet is forwarded from an internal network to an external network, the translation IP is an external source IP of the first packet after the NAPT operation.

16. The method of claim 15, wherein if the second packet is forwarded from the internal network to the external network, the translating step comprises translating the source IP of the second packet into the translation IP.

17. The method of claim 13, wherein if the first packet is forwarded from an external network to an internal network, the translation IP is an internal destination IP of the first packet after the NAPT operation.

18. The method of claim 17, wherein if the second packet is forwarded from the external network to the internal network, the translating step comprises translating the destination IP of the second packet into the translation IP.

19. The method of claim 13, further comprises:
selecting one of a plurality of storage elements of the translation table for each of the first and second packets according to the same identification, a source IP and a destination IP of the first and second packets respectively.

20. The method of claim 19, wherein the selecting step is executed by a hash function.
